(19) United States
(12) Patent Application Publication
(10) Pub. No.: US 2006/0161458 A1
(43) Pub. Date: Jul. 20, 2006

(54) Managed care information system

(76) Inventor: Thomas L. Lauzon, Shelby Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/335,148

(22) Filed: Jan. 19, 2006

Related U.S. Application Data
(60) Provisional application No. 60/645,360, filed on Jan. 19, 2005.

(51) Int. Cl. G06Q 10/00; G06Q 40/00

(52) U.S. Cl. 705/2; 705/4

(57) ABSTRACT

A method for managing the delivery of preventative care services to a membership of a health care plan includes the steps of: providing a membership database having a profile relating to each member of the health care plan, wherein the profile includes at least age, gender, and treatment history; providing a secured web-based interface allowing care providers to enter information to the member database relating to each visit by the members to the care providers; and automatically generating reminders to at least one of the health care plan, the members of the health care plan or the care providers that pre-scheduled or regular preventative services are due and have not been administered.

### CROSS REFERENCE TO RELATED APPLICATION

This application claims priority to U.S. provisional patent application No. 60/645,360, which was filed on Jan. 19, 2005 and is incorporated herein by reference in its entirety.

### BACKGROUND OF THE INVENTION

1. Field of the Invention

The invention relates to the management of health care plans and, more particularly, to a web-based system that facilitates the tracking and rendering of preventative health care services to members of a health care plan.

2. Description of the Related Art

The healthcare community has long recognized the value of delivering age, sex and condition appropriate preventive services. What has been lacking is an effective mechanism for tracking and proactively the delivery of those services. Escalating healthcare costs, driven in part by a rise in the incidence of chronic diseases, makes it imperative that healthcare providers and systems more accurately identify and track individual compliance with recommended preventive services.

Therefore, it remains desirable to provide a system for managing visits by members of a health care plan to care providers in a way that promotes compliance of the health care plan as a whole with predefined preventative service standards.

### SUMMARY OF THE INVENTION

According to one aspect of the invention, a method is provided for managing the delivery of preventative care services to a membership of a health care plan. The method includes the steps of: providing a membership database having a profile relating to each member of the health care plan, wherein the profile includes at least age, gender, and treatment history; providing a secured web-based interface allowing care providers to enter information to the member database relating to each visit by the members to the care providers; and automatically generating reminders to at least one of the health care plan, the members of the health care plan or the care providers that pre-scheduled or regular preventative services are due and have not been administered.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a schematic of a managed care information system according one embodiment of the invention;

FIGS. 2-4 show pages of a web-based interface for the managed care information system;

FIG. 5 is a graph showing the level of compliance of a health care plan to a predefined set of preventative service standards; and

FIG. 6 is a graph showing the level of compliance of a specific care provider's practice to the predefined set of preventative service standards.

### DESCRIPTION OF THE INVENTION

A managed care information system has been developed with the capability of tracking and monitoring the delivery of preventive services for a health care plan's entire membership. The system provides automatic reminders to the health care plan, the members of the health care plan, and the care providers rendering services to the members of the plan to ensure compliance of the plan to a predefined set of preventative service standards. An example of preventative service standards is the Health Care Plan Employer Data and Information Set (HEDIS), which is provided by the National Committee for Quality Assurance (NCQA).

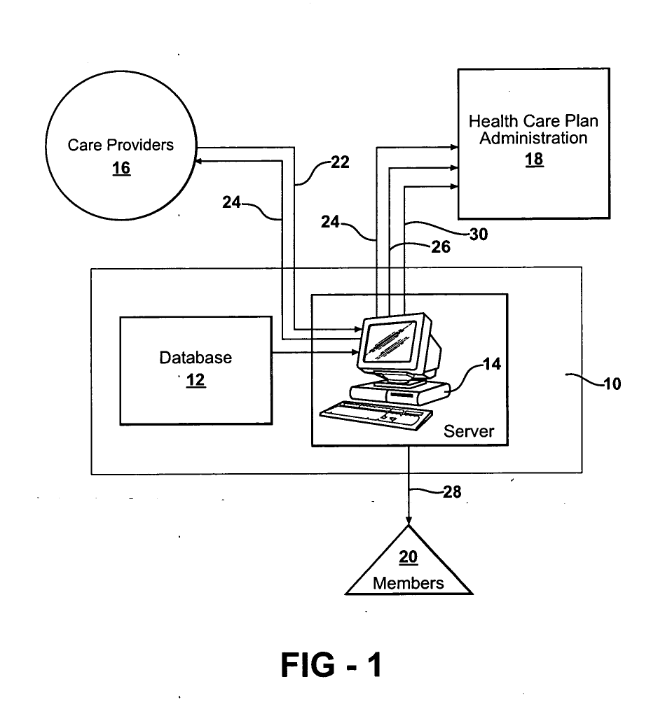

Referring to FIG. 1, the managed care information system is generally indicated at 10. The system 10 includes a database 12. The database 12 includes information related to the history of treatment and care of each member, such as childhood immunizations, pap smears, mammograms and other age, sex and condition appropriate preventive service measures. The database 10 includes other information relevant to the tracking of preventative services for each member, such as contact information, primary care provider, membership number, vital statistics (age, height, weight), etc. Additionally, all standard preventive care measures, such as those stipulated by HEDIS are programmed into the database 12 for each individual member profile and accessible to health care plan staff 18 and the member's primary care provider 16 through the system 10.

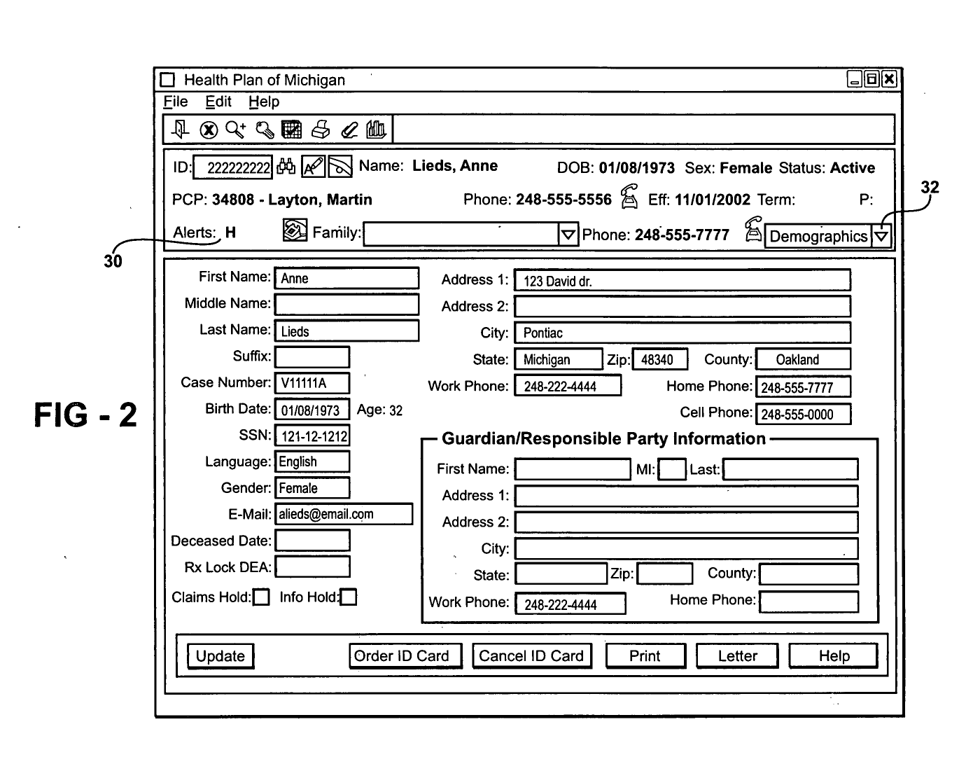

One embodiment of the invention includes a web-based interface that facilitates access to the system 10 and allows entering, revising and viewing information on the system 10. The database 12 and interface are hosted on a server 14. The interface is accessible to care providers 16, health care plan administrators 18 and plan members 20 via internet- or network-enabled computers. Examples of pages from the web-based interface are shown in FIGS. 2-4. A member demographic screen is shown in FIG. 2, which provides information about a specific member of the plan. The member demographic screen includes fields for entering and viewing of each member's information, such as name, address, membership or card number, social security number. The interface also provides a similar screen allowing access, entry, revision and viewing of specific care provider information stored in the system.

Another page (not shown) allows the care providers to enter claims and information 22 related to each visit into the database 10 via the web interface. The interface provides a page having fields for entry and viewing of information relating to visits made by members of the health care plan to the care providers. The system 10 then populates the member's profile with any appropriate information from the claim. For example, if a diabetic member's claim included information that a diabetic retinal eye exam had been performed, that individual's profile would be updated to reflect the delivery of that preventive service.

To ensure compliance of the health care plan and its care providers with HEDIS, the system 10 utilizes various indicators on the web interface to indicate that services for a particular member of the plan are due. For example, an alert code 30 is shown on the member demographic screen when the particular member is in need of regular preventative services. The alert code 30 remains on the screen as long as any preventative services are due. To obtain detailed information about what services are due for the particular member, the user selects the appropriate HEDIS option in a drop down navigation menu 32. The user is then taken to a HEDIS support screen.

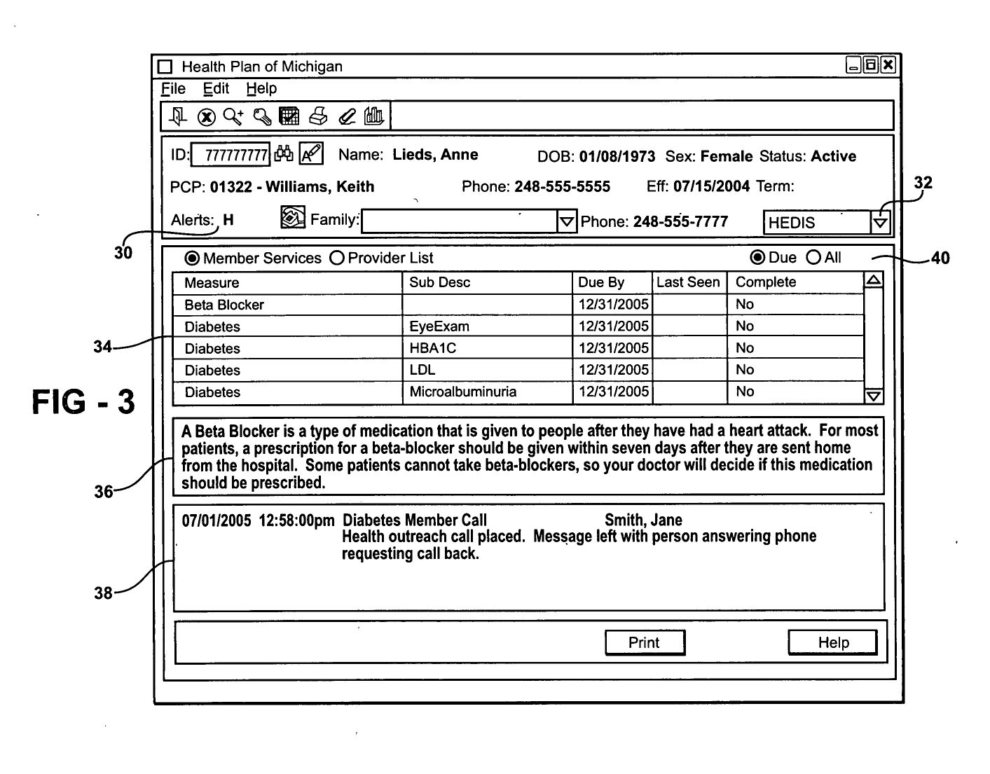

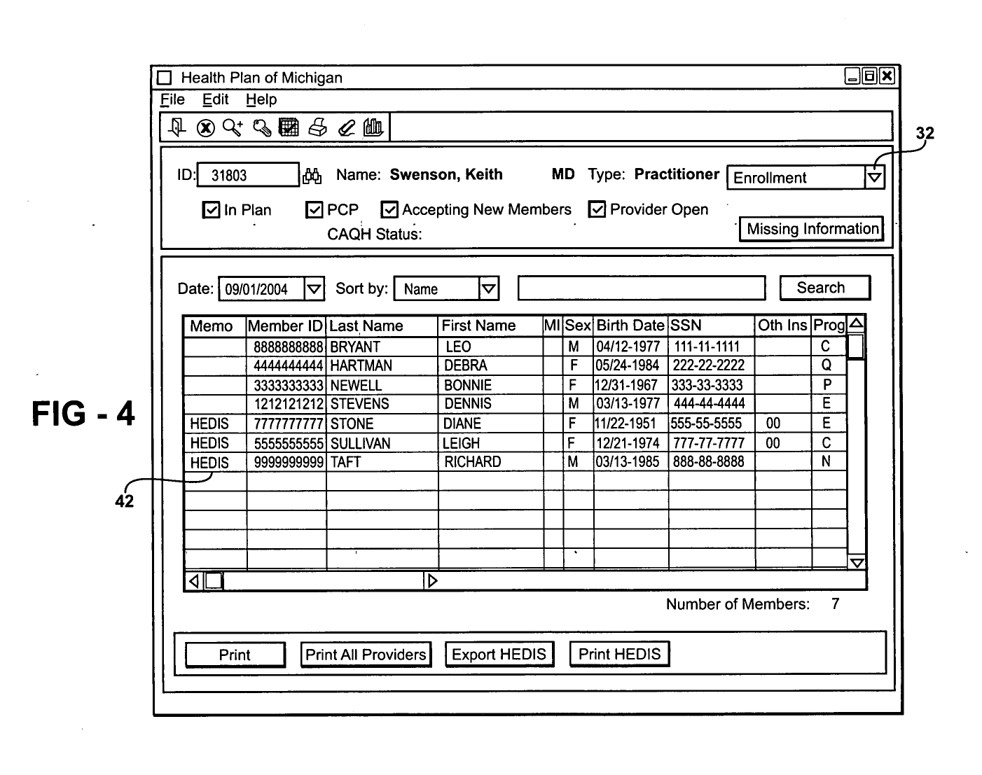

Referring to FIG. 3, the HEDIS support screen also includes the alert code 30. The HEDIS support screen includes a summary window 34, a details window 36 and a log details window 38. The summary window 34 provides a list of preventative services that have been done or are due to be completed. The list can be filtered to show just those that are due by selecting the appropriate filter 40. A user can select a row for a specific service and read details of the procedure in the details window 36. The log details window 38 provides a log of actions taken toward scheduling preventative services still due, which includes details such as date, time, notes and the name of the health care plan employee that took the action. Actions can include mailed correspondence, e-mails, phone calls and messages. When all due preventative services have been completed, the alert code 30 is removed from all screens of the interface and the summary window 34 will indicate that services have been completed. An enrollment screen is shown in FIG. 4; which gives care providers an overview of the members in their practice and indicates by memo 42 the members still in need of preventative services.

The system 10 is also programmed to generate reminders 24 for the health care plan 18 and individual care providers 16. The reminders 24 can be provided in the form of e-mails, printouts, and mailed correspondance that list all members in need of preventative services. The reminders 24 can be provided in any form allowing automatic delivery in response to recognition by the system 10 that preventative services in accordance with HEDIS remain due.

The system 10 also provides to-do or call queues 26 to the health care plan 18 listing all members in need of a specific preventive service, such as all children in need of a specific immunization and the date by which that immunization should be administered. Optionally, the reminders are provided automatically as members are added to the queue. In one embodiment of the invention, calls are made automatically to members listed on the call queue to remind them of services that are due. The reminders can be pre-recorded or can be made by a live operator or plan employee. As calls are made, a log of the conversation or of the placement of the call to the member is entered into the system 10. The call log for a particular member can be recalled in the log details window 38 in the HEDIS support screen shown in FIG. 3. The system 10 tracks the result of each call. The system 10 also tracks the number of call back attempts and maintains the member in the call queue until the member is reached. Wrong phone numbers are indicated in the system 10 and automatically highlighted for instructions to search for a correct number.

Patient profiles are accessible to all primary care providers 16 through the web-based interface within the system 10. When a care provider is checking on patient eligibility, for example, he/she also has the option of accessing the member's health care plan file and viewing member information that includes appropriate preventive services and the member's status relative to the service. Once eligiblity is determined, the system 10 allows the care provider to schedule an appointment for preventative services and make connections between the scheduled appointment and outstanding HEDIS alerts associated with the services.

The web-based interface facilitates automated referral authorization for all services that do not require corporate authorization. Care providers can submit an authorization request online. In most cases, the care provider can receive immediate authorization approval. Where immediate approval is not possible, the request is electronically transferred to a work queue at the plan and a decision is electronically communicated back to the provider. This managed care information system provides the health care plan with the capability to monitor and track ongoing progress toward preventive service goals and institute proactive measures to improve outcomes based on real-time information.

The health care plan's compliance rate with recommended preventive services standards can be graphically displayed to illustrate progress towards meeting the HEDIS standards and alert plan managers to areas where targeted goals are not being achieved. This allows the health care plan to direct more specific outreach efforts toward bringing that area of the program into compliance. Those efforts may include sending reminder lists to individual care providers, providing special call queues for health care plan employees, or special incentives to members, staff and providers to encourage compliance. An algorithm for calculating the plan's compliance rate, and instructions for graphing the plan's compliance and generating reminder lists and call queues is embedded in the executable code that defines the interface. The compliance data and associated graphs are provided to plan administrators and staff via the interface.

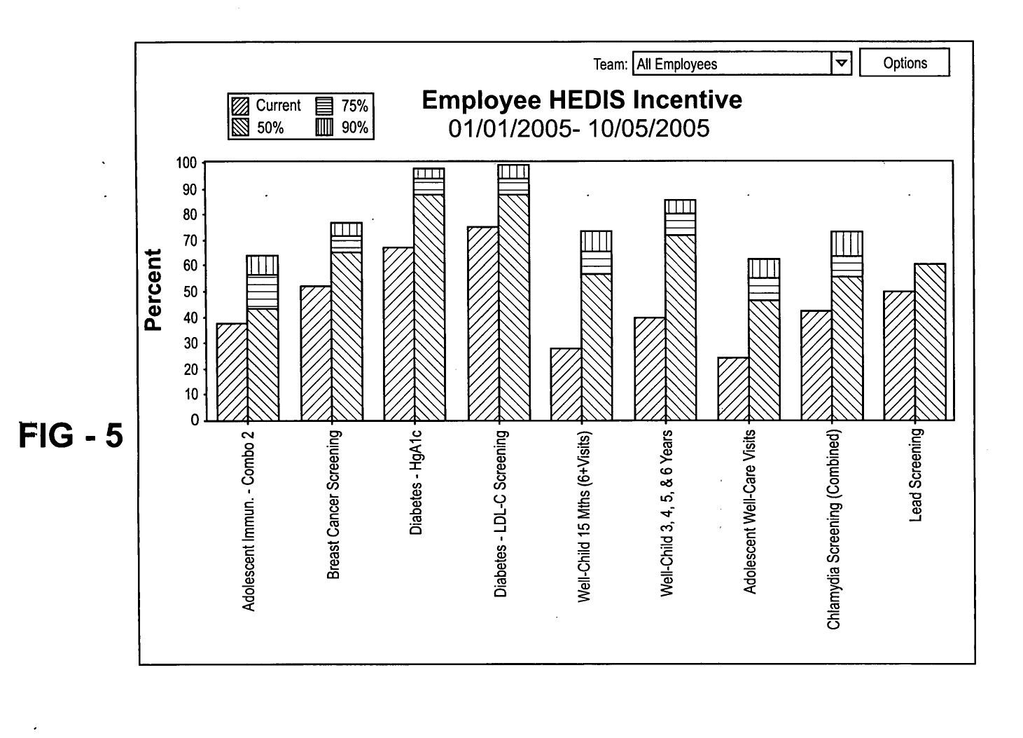

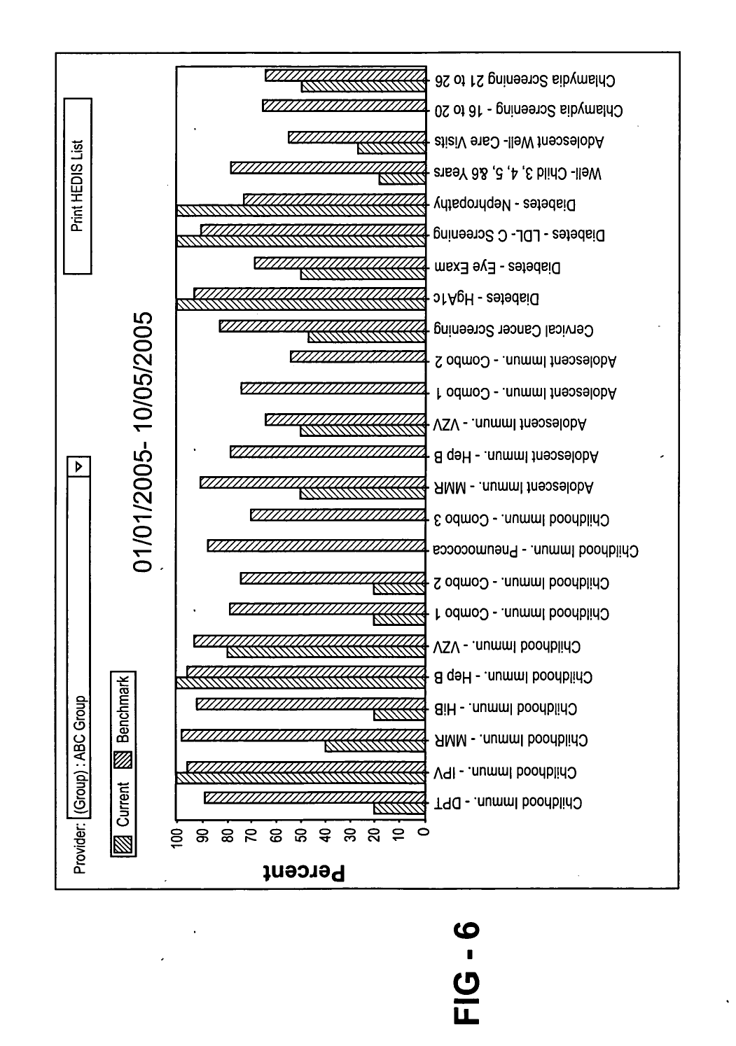

An example of a graph is provided in FIG. 5, which shows the plan's overall compliance to HEDIS standards. In general, the graph shows in bar-graph format the percentage in compliance for each category of preventative services. For each categary, two bars are provided. The first bar provides in real-time the percentage of the membership in compliance for the particular category. Real-time means at the time the information is retrieved. The second bar provides the industry benchmark. The second bar also provides a detailed breakdown of the industry compliance in terms of percentile. In FIG. 5, for example, the plan's compliance for breast cancer screenings is approximately 52% at the time that the graph is compiled. The industry benchmark is approximately 75%, which breaks down as follows: 50^{th} percentile compliance is 65%; 75^{th} percentile compliance is 72%; and 90^{th} percentile compliance is 75%. In FIG. 6, a bar graph shows the compliance of a particular care provider's group to HEDIS standards. The graph provides two bars for each category. The first bar provides the real-time percentage of the group in compliance, while the second bar provides the industry benchmark.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A method of managing the delivery of preventative care services to a membership of a health care plan, said method comprising the steps of:
providing a membership database having a profile relating to each member of the health care plan, wherein the profile includes at least age, gender, and treatment history;
providing an electronic interface allowing care providers to enter information to the member database relating to each visit by the members to the care providers; and
automatically generating reminders that preventative services are due and have not been administered, the reminders being sent to at least one of the health care plan, the members of the health care plan or the care providers.

2. The method as set forth in claim 1 including the step of tracking compliance by the health care plan to predefined preventative service standards.

3. The method as set forth in claim 2 including the step of graphically displaying progress made by the health care plan toward compliance to the predefined preventative service standards.

4. The method as set forth in claim 2 including the step of alerting at least one of health care plan managers, health care plan employees, health care plan members or care providers when the health care plan is not in compliance with the preventative service standards.

5. The method as set forth in claim 1 including the step of automatically authorizing referrals for services not requiring a corporate authorization.

6. The method as set forth in claim 1, wherein the interface allows the care provider to submit authorization requests and receive authorization approvals.

7. The method as set forth in claim 6 including the step of transferring an authorization request to a queue when immediate authorization is not possible.

8. The method as set forth in claim 1 including the step of forming a call queue for members that are to be reminded of preventative services that are due and have not been administered.

9. The method as set forth in claim 8 including the step of automatically calling members to remind them that preventative services are due and have not been administered.

10. The method as set forth in claim 1 wherein the interface is web-based.
